(19) United States
(12) Patent Application Publication
(10) Pub. No.: US 2021/0284129 A1
(43) Pub. Date: Sep. 16, 2021

(54) BEHAVIOR CONTROL APPARATUS AND BEHAVIOR CONTROL METHOD

(71) Applicant: HONDA MOTOR CO., LTD., Tokyo (JP)

(72) Inventor: Masakatsu HORI, WAKO-SHI (JP)

(21) Appl. No.: 17/196,491

(22) Filed: Mar. 9, 2021

(30) Foreign Application Priority Data
Mar. 12, 2020 (JP) 2020-043147

(51) Int. Cl. B60W 20/30; B60W 40/09

(52) U.S. Cl. CPC B60W 20/30; B60W 40/09; B60W 2520/403; B60W 2520/14; B60W 2520/30; B60W 2510/083

(57) ABSTRACT

A behavior control apparatus for an electric vehicle includes a torque balancing unit that sets a distribution between a front wheel driving torque and a rear wheel driving torque according to a target yaw rate; sets the distributed front wheel driving torque to a target front wheel driving torque and sets the distributed rear wheel driving torque to a target rear wheel driving torque in a case where the distribution ratio of the rear wheel driving torque to the front wheel driving torque is less than a limit value; and sets the target front wheel driving torque and the target rear wheel driving torque in a manner that a braking force is produced at least on the rear wheel in a case where the distribution ratio of the rear wheel driving torque to the front wheel driving torque is equal to or more than the limit value.

### CROSS-REFERENCE TO RELATED APPLICATION

This application is based upon and claims the benefit of priority from Japanese Patent Application No. 2020-043147 filed on Mar. 12, 2020, the contents of which are incorporated herein by reference.

### BACKGROUND OF THE INVENTION

### Field of the Invention

The present invention relates to a behavior control apparatus and a behavior control method for a vehicle having one front wheel driving motor that drives both left and right front wheels and one rear wheel driving motor that drives both left and right rear wheels.

### Description of the Related Art

Japanese Patent No. 3214141 discloses that a braking torque control is performed that sets a front-rear distribution and a left-right distribution of target braking torque based on a target yaw rate.

### SUMMARY OF THE INVENTION

Japanese Patent No. 3214141 does not look into the driving torque distribution for the vehicle having one front wheel driving motor that drives both left and right front wheels and one rear wheel driving motor that drives both left and right rear wheels.

The present invention has been devised to solve the problems above. An objective is to provide a behavior control apparatus and a behavior control method that suitably distribute driving torque in a vehicle having one front wheel driving motor that drives both left and right front wheels and one rear wheel driving motor that drives both left and right rear wheels.

The first aspect of the present invention is a behavior control apparatus for a vehicle including one front wheel driving motor that drives left and right front wheels, and one rear wheel driving motor that drives left and right rear wheels. The behavior control apparatus includes a target yaw rate setting unit that sets the target yaw rate of the vehicle; a driving torque distribution setting unit that sets a distribution between a front wheel driving torque output by the front wheel driving motor and a rear wheel driving torque output by the rear wheel driving motor according to the target yaw rate, and sets a target front wheel driving torque and a target rear wheel driving torque based on the distributed front wheel driving torque and the distributed rear wheel driving torque, and a driving motor control unit that controls the front wheel driving motor based on the target front wheel driving torque and controls the rear wheel driving motor based on the target rear wheel driving torque.

The driving torque distribution setting unit sets the distributed front wheel driving torque to the target front wheel driving torque and sets the distributed rear wheel driving torque to the target rear wheel driving torque in a case where the distribution ratio of the rear wheel driving torque to the front wheel driving torque is less than a limit value, and sets the target front wheel driving torque and the target rear wheel driving torque in a manner that a braking force is produced at least between the rear wheel and a road surface in a case where the distribution ratio of the rear wheel driving torque to the front wheel driving torque is equal to or more than the limit value.

The second aspect of the present invention is a behavior control method for a vehicle including one front wheel driving motor that drives left and right front wheels and one rear wheel driving motor that drives left and right rear wheels. The method includes: a target yaw rate setting step of setting a target yaw rate of the vehicle; a driving torque distribution setting step of setting a distribution between a front wheel driving torque output by the front wheel driving motor and a rear wheel driving torque output by the rear wheel driving motor according to the target yaw rate, and setting a target front wheel driving torque and a target rear wheel driving torque based on the distributed front wheel driving torque and the distributed rear wheel driving torque; and a driving motor control step of controlling the front wheel driving motor based on the target front wheel driving torque and controlling the rear wheel driving motor based on the target rear wheel driving torque. The driving torque distribution setting step sets the distributed front wheel driving torque to the target front wheel driving torque and sets the distributed rear wheel driving torque to the target rear wheel driving torque in a case where the distribution ratio of the rear wheel driving torque to the front wheel driving torque is less than a limit value, and sets the target front wheel driving torque and the target rear wheel driving torque in a manner that a braking force is produced at least between the rear wheel and a road surface in a case where the distribution ratio of the rear wheel driving torque to the front wheel driving torque is equal to or more than the limit value.

Due to the present invention, driving torque can suitably distributed.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of an electric vehicle;

FIG. 2 is a block diagram of a behavior control apparatus;

FIG. 3 is a flowchart showing a behavior control process; and

FIG. 4 is a time chart of a turning vehicle.

### DESCRIPTION OF THE PREFERRED EMBODIMENTS

### First Embodiment

[Structure of Electric Vehicle]

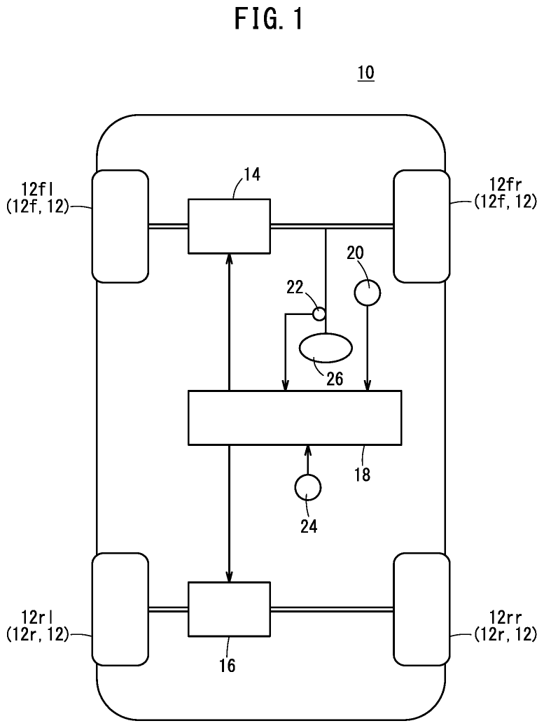

FIG. 1 is a schematic diagram of an electric vehicle 10. The electric vehicle 10 corresponds to a vehicle of the present invention. The electric vehicle 10 of the present embodiment has a front wheel driving motor 14 that drives a left front wheel 12f1 and a right front wheel 12fr, a rear wheel driving motor 16 that drives a left rear wheel 12r1 and a right rear wheel 12rr, and a behavior control apparatus 18 that controls the front wheel driving motor 14 and the rear wheel driving motor 16.

Driving torque output from the front wheel driving motor 14 is equally distributed to the left front wheel 12f1 and the right front wheel 12fr. Driving torque output from the rear wheel driving motor 16 is equally distributed to the left rear wheel 12r1 and the right rear wheel 12rr. The front wheel driving motor 14 and the rear wheel driving motor 16 are controlled by the behavior control apparatus 18.

In the explanation below, the left front wheel 12f1, the right front wheel 12fr, the left rear wheel 12r1, and the right rear wheel 12rr may be called a wheel (wheels) 12 when it is not necessary to distinguish between them. The left front wheel 12f1 and the right front wheel 12fr may be called a front wheel (front wheels) 12f if it is not necessary to distinguish between them. The left rear wheel 12r1 and the right rear wheel 12rr may be called a rear wheel (rear wheels) 12r when it is not necessary to distinguish between them.

The electric vehicle 10 is equipped with various sensors: an accelerator pedal opening amount sensor 20, a steering angle sensor 22, and a yaw rate sensor 24.

The accelerator pedal opening amount sensor 20 detects the amount of accelerator pedal depression (accelerator pedal opening amount). The accelerator pedal is not shown here. The steering angle sensor 22 detects a steering angle of a steering wheel 26. The yaw rate sensor 24 detects a yaw rate about the center of gravity of the electric vehicle 10.

### [Structure of Behavior Control Apparatus]

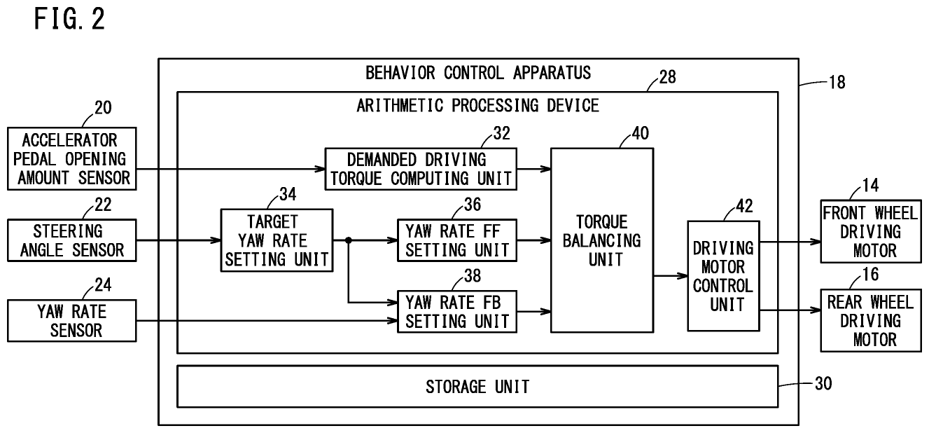

FIG. 2 is a block diagram of the behavior control apparatus 18. The behavior control apparatus 18 includes an arithmetic processing device 28 and a storage unit 30.

The arithmetic processing device 28 may be formed by a processor such as a central processing unit (CPU) and a graphics processing unit (GPU), that is, may be formed by processing circuitry.

The arithmetic processing device 28 is equipped with a determining unit and a control unit, which are not shown. The determining unit and the control unit may be realized by a program stored in the storage unit 30 being executed by the arithmetic processing device 28. At least part of the determining unit and the control unit may be realized by an integrated circuit such as an application specific integrated circuit (ASIC) and a field-programmable gate array (FPGA). At least part of the determining unit and the control unit may be formed by an electronic circuit including discrete devices.

The storage unit 30 may be formed by volatile memory (not shown) and non-volatile memory (not shown). An example of the volatile memory is random access memory (RAM). Examples of the non-volatile memory are read only memory (ROM) and flash memory. Data and the like may be stored, for example, in the volatile memory. Programs, tables, maps and the like may be stored, for example, in the non-volatile memory. At least part of the storage unit 30 may be included in the above-described processor, the above-described integrated circuit, and so on.

The behavior control apparatus 18 controls the front wheel driving motor 14 and the rear wheel driving motor 16 in a manner that driving torque corresponding to a demanded driving torque from a driver is output. The behavior control apparatus 18 controls the front wheel driving motor 14 and the rear wheel driving motor 16 in a manner that a yaw rate corresponding a target yaw rate is produced.

The behavior control apparatus 18 includes a demanded driving torque computing unit 32, a target yaw rate setting unit 34, a yaw rate FF setting unit 36, a yaw rate FB setting unit 38, a torque balancing unit 40, and a driving motor control unit 42.

The demanded driving torque computing unit 32, the target yaw rate setting unit 34, the yaw rate FF setting unit 36, the yaw rate FB setting unit 38, the torque balancing unit 40, and the driving motor control unit 42 are realized by a program stored in the storage unit 30 being executed by the processor of the arithmetic processing device 28.

The demanded driving torque computing unit 32 computes the demanded driving torque from the driver. The demanded driving torque is computed depending on the accelerator pedal opening amount detected by the accelerator pedal opening amount sensor 20.

The target yaw rate setting unit 34 sets a target yaw rate. The target yaw rate is set according to a vehicle model into which a steering angle detected by the steering angle sensor 22 has been input. The target yaw rate setting unit 34 uses a vehicle model given when the road surface μ equals 1.

The yaw rate FF setting unit 36 sets a feedforward demand turning moment (hereinafter, “FF demand turning moment”). The FF demand turning moment is set depending on the target yaw rate set by the target yaw rate setting unit 34. The FF demand turning moment is set to be larger as the target yaw rate becomes larger.

The yaw rate FB setting unit 38 sets a feedback demand turning moment (hereinafter, “FB demand turning moment”). The FB demand turning moment is set depending on the target yaw rate set by the target yaw rate setting unit 34 and a yaw rate (hereinafter, “actual yaw rate”) detected by the yaw rate sensor 24. If the actual yaw rate is smaller than the target yaw rate, the FB demand turning moment is set in a direction in which the electric vehicle 10 is going to turn. If the actual yaw rate is larger than the target yaw rate, the FB demand turning moment is set in the opposite direction. The FB demand turning moment is set to be larger as the difference between the target yaw rate and the actual yaw rate becomes larger.

The torque balancing unit 40 sets a target front wheel driving torque Tf* and a target rear wheel driving torque Tr*. The torque balancing unit 40 corresponds to a driving torque distribution setting unit of the claimed invention.

The torque balancing unit 40 distributes the demanded driving torque to a front wheel driving torque output by the front wheel driving motor 14 and a rear wheel driving torque output by the rear wheel driving motor 16 based on the demanded driving torque, a ground load (vertical load) of the front wheel 12f, and a ground load of the rear wheel 12r. The front wheel driving torque Tf and the rear wheel driving torque Tr are set to satisfy the following equations:

Tf=T×Fzf/(Fzf+Fzr) and

Tr=T×Fzr/(Fzf+Fzr)

where T denotes the demanded driving torque, Fzf denotes the ground load of the front wheel 12f, and Fzr denotes the ground load of the rear wheel 12r.

That is, the demanded driving torque is distributed to the front wheel driving torque and the rear wheel driving torque depending on the ground load of the front wheel 12f and the ground load of the rear wheel 12r. The torque balancing unit 40 corrects or adjusts, depending on the FF demand turning moment and the FB demand turning moment, the distribution between the front wheel driving torque and the rear wheel driving torque that has been set according to the demanded driving torque. The torque balancing unit 40 sets a final target front wheel driving torque Tf* and a final target rear wheel driving torque Tr*.

The torque balancing unit 40 adjusts the distribution in a manner that as the FF demand turning moment becomes larger, the amount of distribution to the front wheel driving torque becomes smaller and the amount of distribution to the rear wheel driving torque becomes larger. As a result, a cornering force of the front wheel 12f can be increased, whereby a turning performance of the electric vehicle 10 improves.

Further, the torque balancing unit 40 adjusts the distribution between the front wheel driving torque and the rear wheel driving torque depending on the FB demand turning moment. If the FB demand turning moment has been set in the direction in which the electric vehicle 10 turns, the distribution between the front wheel driving torque and the rear wheel driving torque is adjusted in a manner that the larger the FB demand turning moment is, the smaller the amount of distribution to the front wheel driving torque is and the larger the amount of distribution to the rear wheel driving torque is. As a result, the cornering force of the front wheel 12f can be increased, whereby the turning performance of the electric vehicle 10 improves. If the FB demand turning moment has been set in the opposite direction, the distribution between the front wheel driving torque and the rear wheel driving torque is adjusted in a manner that the larger the FB demand turning moment is, the larger the amount of distribution to the front wheel driving torque is and the smaller the amount of distribution to the rear wheel driving torque is. As a result, the cornering force of the rear wheel 12r can be increased, whereby the stability of the electric vehicle 10 improves.

The sum of the front wheel driving torque and the rear wheel driving torque that have been adjusted according to the FF demand turning moment and the FB demand turning moment is the demanded driving torque.

When a distribution ratio (ratio of distribution) of the adjusted rear wheel driving torque to the adjusted front wheel driving torque is equal to or less than a limit value, the torque balancing unit 40 sets the adjusted front wheel driving torque to the target front wheel driving torque Tf* and sets the adjusted rear wheel driving torque to the target rear wheel driving torque Tr*.

When the distribution ratio of the adjusted rear wheel driving torque to the adjusted front wheel driving torque is larger than the limit value, the torque balancing unit 40 sets the target front wheel driving torque Tf* in a manner that a braking force is produced between the front wheel 12f and the road surface and, at the same time, the torque balancing unit 40 sets the target rear wheel driving torque Tr* in a manner that the braking force is produced between the rear wheel 12r and the road surface. At this time, the target front wheel driving torque Tf* and the target rear wheel driving torque Tr* are set in a manner that the distribution ratio of the rear wheel driving torque to the front wheel driving torque equals the limit value. For example, when the limit value for the distribution ratio of the rear wheel driving torque to the front wheel driving torque is 100, the target front wheel driving torque Tf* is set zero and the target rear wheel driving torque Tr* is set in a manner that the braking force is produced only on the rear wheel 12r.

The driving motor control unit 42 control the front wheel driving motor 14 in a manner that the driving torque output by the front wheel driving motor 14 becomes the target front wheel driving torque Tf*. The driving motor control unit 42 controls the rear wheel driving motor 16 in a manner that the driving torque output by the rear wheel driving motor 16 becomes the target rear wheel driving torque Tr*.

### [Behavior Control Process]

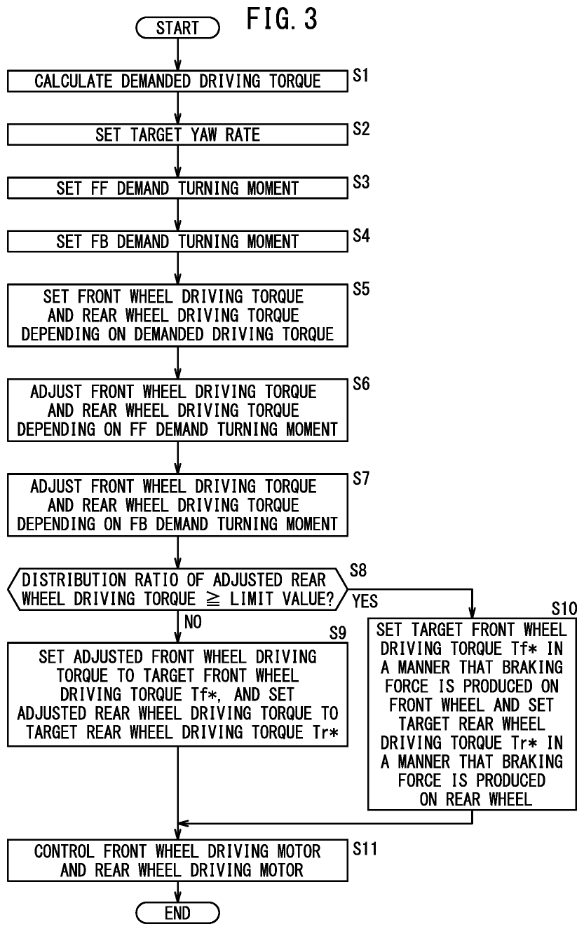

FIG. 3 is a flowchart showing a behavior control process performed by the behavior control apparatus 18. The behavior control process is repeatedly performed at a predetermined interval of time, when an activation switch of the electric vehicle 10 is in an ON state.

In step S1, the demanded driving torque computing unit 32 calculates the demanded driving torque from the driver, and the process then moves to step S2. The demanded driving torque is calculated depending on the accelerator pedal opening amount detected by the accelerator pedal opening amount sensor 20.

In step S2, the target yaw rate setting unit 34 sets the target yaw rate, and the process then goes to step S3. The target yaw rate is set based on a vehicle model into which the steering angle detected by the steering angle sensor 22 has been input.

In step S3, the yaw rate FF setting unit 36 sets the FF demand turning moment, and the process then goes to step S4. The FF demand turning moment is set depending on the target yaw rate set by the target yaw rate setting unit 34.

In step S4, the yaw rate FB setting unit 38 sets the FB demand turning moment, and the process then goes to step S5. The FB demand turning moment is set depending on the target yaw rate set by the target yaw rate setting unit 34 and the actual yaw rate detected by the yaw rate sensor 24.

In step S5, the torque balancing unit 40 sets the front wheel driving torque and the rear wheel driving torque depending on the demanded driving torque, and the process then goes to step S6. The front wheel driving torque and the rear wheel driving torque are set depending on the demanded driving torque and the ground load (vertical load) of the front wheel 12f and the ground load (vertical load) of the rear wheel 12r obtained from the demanded driving torque.

In step S6, the torque balancing unit 40 corrects or adjusts the front wheel driving torque and the rear wheel driving torque depending on the FF demand turning moment, and the process then goes to step S7. The distribution between the front wheel driving torque and the rear wheel driving torque is adjusted in a manner that, as the FF demand turning moment increases, the amount of distribution to the front wheel driving torque becomes smaller and the amount of distribution to the rear wheel driving torque becomes larger.

In step S7, the torque balancing unit 40 corrects or adjusts the front wheel driving torque and the rear wheel driving torque depending on the FB demand turning moment, and the process then goes to step S8. When the FB demand turning moment has been set in the direction in which the electric vehicle 10 turns, the distribution between the front wheel driving torque and the rear wheel driving torque is adjusted in a manner that as the FB demand turning moment increases, the amount of distribution to the front wheel driving torque becomes smaller and the amount of distribution to the rear wheel driving torque becomes larger. When the FB demand turning moment has been set in the opposite direction, the distribution between the front wheel driving torque and the rear wheel driving torque is adjusted in a manner that as the FB demand turning moment increases, the amount of distribution to the front wheel driving torque becomes larger and the amount of distribution to the rear wheel driving torque becomes smaller.

In step S8, the torque balancing unit 40 determines whether or not the distribution ratio of the adjusted rear wheel driving torque to the adjusted front wheel driving torque is equal to or more than the limit value (i.e., whether the distribution ratio the limit value). When the distribution ratio of the adjusted rear wheel driving torque to the adjusted front wheel driving torque is equal to or more than the limit value, the process goes to step S10. When the distribution ratio of the adjusted rear wheel driving torque to the adjusted front wheel driving torque is less than the limit value, the process goes to step S9.

In step S9, the torque balancing unit 40 sets the target front wheel driving torque Tf* and the target rear wheel driving torque Tr*, and the process then goes to step S11. The target front wheel driving torque Tf* is set to the adjusted front wheel driving torque of step S6 and step S7. The target rear wheel driving torque Tr* is set to the adjusted rear wheel driving torque of steps S6 and S7.

In step S10, the torque balancing unit 40 sets the target front wheel driving torque Tf* and the target rear wheel driving torque Tr*, and the process then goes to step S11. The target front wheel driving torque Tf* is set in a manner that the braking force occurs between the front wheel 12f and the road surface. The target rear wheel driving torque Tr* is set in a manner that the braking force occurs between the rear wheel 12r and the road surface. The target front wheel driving torque Tf* may be set in a manner that neither of the braking force and the driving force occurs between the front wheel 12f and the road surface.

In step S11, the driving motor control unit 42 controls the front wheel driving motor 14 and the rear wheel driving motor 16. The behavior control process ends. The front wheel driving motor 14 is controlled in a manner that the driving torque output by the front wheel driving motor 14 becomes the target front wheel driving torque Tf*. The rear wheel driving motor 16 is controlled in a manner that the driving torque output by the rear wheel driving motor 16 becomes the target rear wheel driving torque Tr*.

### Advantageous Effects

Conventionally, it has been studied to stabilize the behavior of a vehicle by causing differences of driving force between the left front wheel and the right front wheel and between the left rear wheel and the right rear wheel.

In order to cause the differences of driving force between the left front wheel and the right front wheel and between the left rear wheel and the right rear wheel, it is necessary to provide a driving motor to each wheel or to provide a driving torque distribution mechanism that adjusts the driving torque that is distributed from the driving motor to the left and right wheels. In this case, there is a problem that costs of a vehicle increase.

Another possible way to cause the differences of driving force between the left front wheel and the right front wheel and between the left rear wheel and the right rear wheel is to give braking torque to each wheel with a hydraulic brake. However, if the braking torque is given to each wheel with the hydraulic brake, there is a problem that energy efficiency worsens since the hydraulic brake cannot recover energy.

The behavior control apparatus 18 of the present embodiment stabilizes behavior of the electric vehicle 10 by setting the distribution between the front wheel driving torque of the front wheel driving motor 14 and the rear wheel driving torque of the rear wheel driving motor 16 depending on the target yaw rate and the actual yaw rate. However, if the actual yaw rate is small in comparison with the target yaw rate, there may be a case where the turning performance of the vehicle does not sufficiently improve even if the distribution ratio of the rear wheel driving torque to the front wheel driving torque is increased to the limit value.

In order to deal with this situation, the behavior control apparatus 18 of the present embodiment sets the target front wheel driving torque Tf* and the target rear wheel driving torque Tr* in a manner that the braking force is generated at least on the rear wheel 12r when the distribution ratio of the rear wheel driving torque to the front wheel driving wheel torque is equal to or more than the limit value. In this way, the ground load (vertical load) of the front wheel 12f increases and thus the cornering force of the front wheel 12f increases, whereby the turning performance of the electric vehicle 10 improves. Further, because the braking force of the rear wheel 12r is created by the regeneration performed by the rear wheel driving motor 16, energy can be recovered and energy efficiency can be improved.

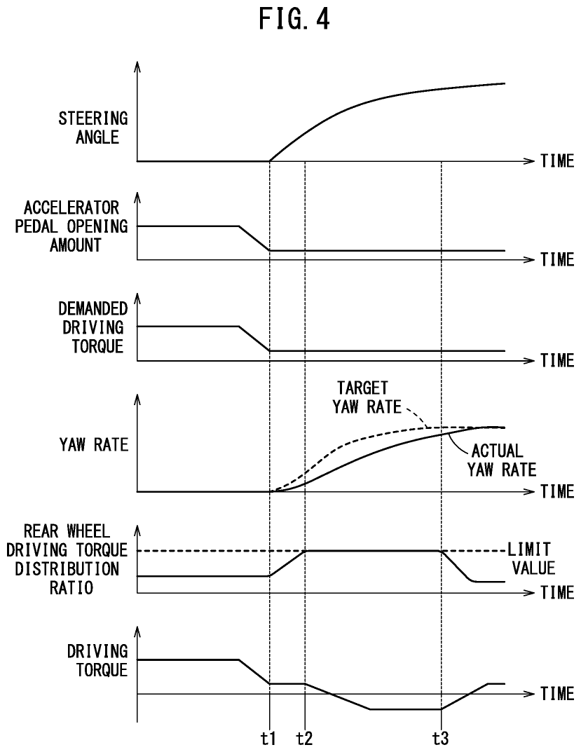

FIG. 4 is a time chart of a turning vehicle. The time chart of FIG. 4 shows change-over-time of the following: a steering angle; an accelerator pedal opening amount; a demanded driving torque; a target yaw rate; an actual yaw rate; a distribution ratio of the rear wheel driving torque to the front wheel driving torque; and a driving torque of the entire electric vehicle 10. The driving torque of the entire electric vehicle 10 is the sum of the front wheel driving torque output by the front wheel driving motor 14 and the rear wheel driving torque output by the rear wheel driving motor 16.

As shown in FIG. 4, at time point t1, the target yaw rate starts increasing as the steering angle increases as a result of manipulation of the steering wheel 26. If the increase of the actual yaw rate does not follow the increase of the target yaw rate, the amount of distribution of the demanded driving torque to the front wheel driving torque is reduced and the amount of distribution of the demanded driving torque to the rear wheel driving torque is increased. In this way, the cornering force of the front wheel 12f can be increased, whereby the turning performance of the electric vehicle 10 improves. However, if the distribution ratio of the rear wheel driving torque to the front wheel driving torque becomes equal to or more than the limit value at time point t2, the amount of distribution to the rear wheel driving torque cannot be increased.

To address this situation, the target front wheel driving torque Tf* and the target rear wheel driving torque Tr* are set in a manner that the braking force is produced at least on the rear wheel 12r, whereby the driving torque of the entire electric vehicle 10 is reduced. As a result, the ground load of the front wheel 12f increases and the cornering force of the front wheel 12f can be increased, whereby the turning performance of the electric vehicle 10 improves. Since the braking force of the rear wheel 12r is produced by the regeneration of the rear wheel driving motor 16, energy efficiency can be improved.

When the distribution ratio of the rear wheel driving torque to the front wheel driving torque becomes less than the limit value at time point t3, the target front wheel driving torque Tf* and the target rear wheel driving torque Tr* are set in a manner that the driving torque of the entire electric vehicle 10 equals the demanded driving torque.

[Technical Ideas Obtained from Embodiments]

Technical ideas understandable from the above-described embodiments will be described below.

The behavior control apparatus (18) for the vehicle (10) including one front wheel driving motor (14) that drives the left and right front wheels (12f) and one rear wheel driving motor (16) that drives the left and right rear wheels (12r) is provided. The behavior control apparatus includes the target yaw rate setting unit (34) that sets the target yaw rate of the vehicle, the driving torque distribution setting unit (40) that sets the distribution between the front wheel driving torque output by the front wheel driving motor and the rear wheel driving torque output by the rear wheel driving motor according to the target yaw rate, and sets the target front wheel driving torque and the target rear wheel driving torque based on the distributed front wheel driving torque and the distributed rear wheel driving torque, and the driving motor control unit (42) that controls the front wheel driving motor based on the target front wheel driving torque and controls the rear wheel driving motor based on the target rear wheel driving torque. The driving torque distribution setting unit sets the distributed front wheel driving torque to the target front wheel driving torque and sets the distributed rear wheel driving torque to the target rear wheel driving torque in a case where the distribution ratio of the rear wheel driving torque to the front wheel driving torque is less than the limit value, and sets the target front wheel driving torque and the target rear wheel driving torque in a manner that the braking force is produced at least between the rear wheel and the road surface in a case where the distribution ratio of the rear wheel driving torque to the front wheel driving torque is equal to or more than the limit value.

The behavior control method for the vehicle that includes one front wheel driving motor that drives the left and right front wheels and one rear wheel driving motor that drives the left and right rear wheels is provided. The method includes the target yaw rate setting step of setting the target yaw rate of the vehicle, the driving torque distribution setting step of setting the distribution between the front wheel driving torque output by the front wheel driving motor and the rear wheel driving torque output by the rear wheel driving motor according to the target yaw rate, and setting the target front wheel driving torque and the target rear wheel driving torque based on the distributed front wheel driving torque and the distributed rear wheel driving torque, and the driving motor control step of controlling the front wheel driving motor based on the target front wheel driving torque and controlling the rear wheel driving motor based on the target rear wheel driving torque. The driving torque distribution setting step sets the distributed front wheel driving torque to the target front wheel driving torque and sets the distributed rear wheel driving torque to the target rear wheel driving torque in a case where the distribution ratio of the rear wheel driving torque to the front wheel driving torque is less than the limit value, and sets the target front wheel driving torque and the target rear wheel driving torque in a manner that the braking force is produced at least between the rear wheel and the road surface in a case where the distribution ratio of the rear wheel driving torque to the front wheel driving torque is equal to or more than the limit value.

The present invention is not limited to the above-described embodiment, and various modifications can be made without departing from the gist of the present invention.

What is claimed is:

1. A behavior control apparatus for a vehicle, the vehicle comprising:
one front wheel driving motor configured to drive left and right front wheels; and
one rear wheel driving motor configured to drive left and right rear wheels,
the behavior control apparatus comprising one or more processors that execute computer-executable instructions stored in a memory,
wherein the one or more processors execute the computer-executable instructions to thereby cause the behavior control apparatus to:
set a target yaw rate of the vehicle;
set a distribution between a front wheel driving torque output by the front wheel driving motor and a rear wheel driving torque output by the rear wheel driving motor according to the set target yaw rate;
set the distributed front wheel driving torque to the target front wheel driving torque and set the distributed rear wheel driving torque to the target rear wheel driving torque in a case where a ratio of the set distribution of the rear wheel driving torque to the front wheel driving torque is less than a limit value; and
set the target front wheel driving torque and the target rear wheel driving torque in a manner that a braking force is produced at least between the rear wheel and a road surface in a case where the ratio of the set distribution of the rear wheel driving torque to the front wheel driving torque is equal to or more than the limit value.

2. A behavior control method for a vehicle that includes one front wheel driving motor configured to drive left and right front wheels and one rear wheel driving motor configured to drive left and right rear wheels,
the method comprising:
setting a target yaw rate of the vehicle;
setting a distribution between a front wheel driving torque output by the front wheel driving motor and a rear wheel driving torque output by the rear wheel driving motor according to the set target yaw rate;
setting the distributed front wheel driving torque to the target front wheel driving torque and setting the distributed rear wheel driving torque to the target rear wheel driving torque in a case where a ratio of the set distribution of the rear wheel driving torque to the front wheel driving torque is less than a limit value; and
setting the target front wheel driving torque and the target rear wheel driving torque in a manner that a braking force is produced at least between the rear wheel and a road surface in a case where the ratio of the set distribution of the rear wheel driving torque to the front wheel driving torque is equal to or more than the limit value.
